(19) United States
(12) Patent Application Publication
(10) Pub. No.: US 2004/0100505 A1
(43) Pub. Date: May 27, 2004

(54) System for and method of prioritizing menu information

(76) Inventor: Robert Paul Cazier, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/301,020

(22) Filed: Nov. 21, 2002

(51) Int. Cl. G09G 5/00

(52) U.S. Cl. 345/811; 345/825; 345/812

(57) ABSTRACT

A method for ordering selectable functions of a peripheral device comprising coupling the peripheral device to a remote device, generating function selection history, and configuring the selectable functions displayed by the peripheral device in accordance with function selection history using data transferred from the remote device to the peripheral device.

### FIELD OF THE INVENTION

The present invention generally relates to menus used in peripheral devices and, more specifically, to prioritization of individual menu items based on usage patterns of the specific user.

### BACKGROUND

Peripheral electronic devices are increasingly prevalent and provide more functions than ever before. In large part, this increase in peripheral usage has occurred because peripherals, such as cameras, telephones and televisions, have become smaller as electronic technology has grown in sophistication. Technology advances continue to allow peripheral device manufacturers to reduce the size of devices while retaining the full functionality of a larger device. This reduction in size of electronic devices often results in corresponding limitations in the device's input/output capabilities. Peripheral devices typically include a static menu structure that allows the user to select desired functions. While large devices such as desktop computers typically provide an efficient means of user interaction, such as keyboards or pointing devices, the use of such interface devices with a peripheral device may defeat the manufacturer's size reduction efforts and may be impractical.

### SUMMARY

An embodiment of the present invention may include a method for ordering selectable functions of a peripheral device comprising coupling the peripheral device to a remote device, generating function selection history, and configuring selectable functions displayed by the peripheral device in accordance with function selection history using data transferred from the remote device to the peripheral device.

Another embodiment of the present invention may include a digital image acquisition system comprised of means for acquiring digital images, means for providing a plurality of selectable functions, and means for ordering the plurality of selectable functions according to frequency of use.

Yet another embodiment of the present invention may include a system for ordering selectable functions that are displayed on a device comprising a device, a display disposed on the device, a menu of selectable functions displayed on the display; and an analysis device for analyzing user selection of selectable functions, the analysis device communicatively connectable to the device such that the analysis device configures the menu of selectable functions according to analysis of user selection of selectable functions.

Still another embodiment of the present invention may include a computer program product comprising computer-readable code stored on computer-readable medium, the computer program comprising computer readable program code means for generating a function selection history, computer readable program code means for generating a prioritization file, and computer readable program code means for reorganizing a selectable function menu on a peripheral device connected to a computer.

Another embodiment of the present invention may include a method for ordering selectable functions of a peripheral device comprising coupling the peripheral device to a remote device, generating a function selection history, and configuring selectable functions displayed by the peripheral device by category in accordance with the function selection history using data transferred from the remote device to the peripheral device.

Yet another embodiment of the present invention may include an apparatus for ordering selectable functions of a peripheral device comprising means for generating a peripheral device function selection history, means for generating a prioritization file, and means for reorganizing peripheral device selectable functions in accordance with the prioritization file.

Still another embodiment of the present invention may include an apparatus comprising a peripheral device, a selectable function menu displayed by the peripheral device, the peripheral device communicatively connectable to a remote device, and the peripheral device selectable function menu configurable in accordance with prioritization file data communicated to the peripheral device by the remote device.

### BRIEF DESCRIPTION OF THE DRAWINGS

FIG. 1 shows a flow diagram illustrating a method of configuring a menu displayed by a peripheral device;

FIG. 2 shows a peripheral device according to an embodiment of the present invention;

FIG. 3 shows a menu arrangement used by a peripheral device in an embodiment of the present invention;

FIG. 4 is a block diagram illustrating the components of a system according to an embodiment of the present invention;

FIG. 5 is a flow diagram illustrating a method of configuring selectable functions displayed by a peripheral device;

FIG. 6 shows a peripheral device according to an embodiment of the invention;

FIG. 7 shows a selectable function menu displayed by a peripheral device according to an embodiment of the present invention; and

FIG. 8 shows a flow diagram illustrating a method of configuring selectable functions categories.

### DETAILED DESCRIPTION

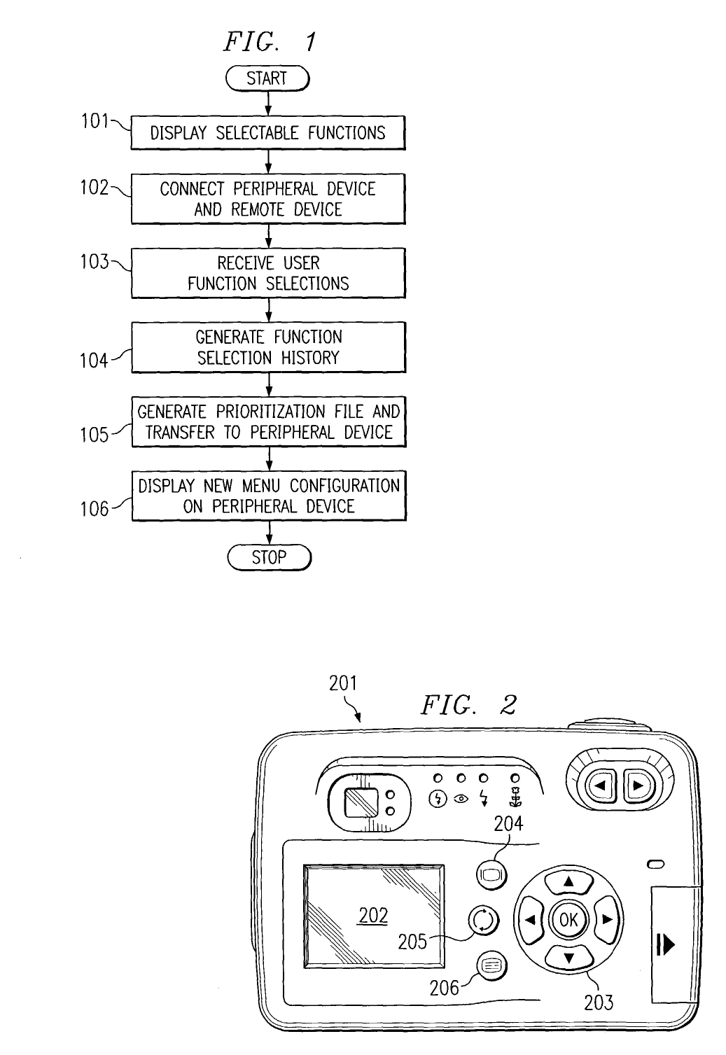

FIG. 1 shows a flow diagram illustrating a method of configuring a menu displayed by a peripheral device. In step 101, the selectable functions of a peripheral device are displayed to a user. The peripheral device may be any electronic device that allows user selection of incorporated functionality. The peripheral device may include, without limitation, a camera, a scanner, a printer, a modem, a mobile telephone, a Personal Digital Assistant (PDA), an electronic device for playing previously recorded music, a laptop computer, a global positioning system, an analytic instrument or a similar device. In one embodiment the peripheral device may be a digital image acquisition device, such as a digital camera or a video camera. In other embodiments, the peripheral device may be an x-ray machine, a infrared camera or a telescope.

A peripheral device may use any of a number of methods to display selectable functions. In one embodiment, selectable functions are displayed using Liquid Crystal Display (LCD) panels. Selectable functions displayed by a peripheral device may be the functions for which the device was intended. For example, a laser printer may display a list of functions that allow the user to select parameters such as print density, speed or paper size. In one embodiment, a camera may display selectable functions such as shutter speed, exposure time or output format. In another embodiment, a digital camera may display sharing functions. Sharing functions include commands to print one copy of an image, print two copies of an image, e-mail an image or functions that allow the distribution of acquired images.

In step 102, a peripheral device may be connected to a remote device. “Remote device” means any device that is remote in distance or physically separate from the peripheral device. A remote device may be located physically next to and directly, electrically connected to a peripheral device, or it may be located apart from the peripheral device and connected via the internet, wired or unwired communications link or a similar manner. A remote device may include devices that are capable of exchanging data with the peripheral device. Some embodiments may use devices such as mainframe computers, servers, or personal digital assistants. These remote devices may be located physically close to the peripheral device or located many miles away and accessed via an electronic connection such as the Internet, a Local Area Network (LAN), a Wide Area Network (WAN), or similar means. A personal computer may be used as a remote device. A remote device may be connected to a peripheral device using any of a number of connection methods that support communication between the two devices. Connection methods may include direct connections, such as parallel or serial communications, Ethernet, Universal Service Bus (USB) or other such methods, or may include wireless connections using electromagnetic energy, such as infrared or radio connections. One embodiment may use a USB connection between a peripheral device and a remote device. The connection may also be a network connection through the Internet or some other multiple-device method of communication.

In step 103, a user may select selectable functions displayed by a peripheral device. Selection of selectable functions may be accomplished by a number of methods, such as touch-screen selection, mouse or pointer selection, or keyboard input. In a preferred embodiment, a user may select selectable functions using four-way arrows and a selection button, such as 4-way controller and OK button 203 of FIG. 2.

In step 104, a function selection history is generated. The function selection history may be a stored record of the number of times a user selects a specific selectable function. The function selection history may record such user selection over a period of time, or it may keep a permanent record. In one embodiment, a function selection history may be reset or cleared, such that all record of selected selectable functions may be set to zero. A function selection history may be a file stored on a remote device that tracks user selection of selectable functions on a peripheral device. The function selection history may be generated in one embodiment by tracking the number of times that a specific file type is generated by the peripheral device. For example, functions that result in a printed output from a peripheral device may generate a digital print order specification file that is sent from the peripheral device to a remote device which is a printing-capable device. Similarly, e-mailing output from a peripheral device may generate an Extensible Mark-up Language (XML) file that is transferred from the peripheral device to a remote device which is a network-connected device. A remote device according to this embodiment may generate a selectable function history by counting the number of times each file type is generated by the peripheral device. Note that this is only one of a number of possible methods of generating a selectable function history.

In another embodiment, a peripheral device may itself count and store in its own memory the number of times that different selectable functions are selected and may periodically transfer this information to a remote device which updates its function selection history files after each such transfer. As a further example, a peripheral device may query a user for instructions on the ordering of menu items. In this example, a user may position the e-mail connection first, regardless of the number of times it is selected, to minimize the amount of time spent online transferring digital images.

In step 105, the function selection history generated in step 104 may be used by a remote device to generate a prioritization file. A prioritization file may contain instructions for reorganizing the selectable functions that are displayed by a peripheral device and may be readable by both a remote device and a peripheral device. In one embodiment of the present invention, selectable functions may be prioritized such that the display of selectable functions are organized so that the most frequently used selectable functions are the easiest to select. For example, selectable functions may be ordered in a vertical menu arrangement in some embodiments. In this ordering arrangement, selectable functions located at the top of the menu list may be easier to find and to select than selectable functions located at the bottom of the menu list. In this example, a prioritization file may contain reorganization instructions that will result in the most frequently used selectable functions, as determined by the function selection history generated in step 104, being located at the top of the menu list. In one embodiment, a vertical menu arrangement is used by the peripheral device to display selectable functions, and the prioritization file uses XML commands to communicate prioritization information from the remote device to the peripheral device. Note that in other embodiments different file types may be used, including ASCII and text files, Hyper-Text Mark-up Language (HTML), WML, and other file structures that enable cross-platform communication. In step 106, the new selectable function organization is displayed by the peripheral device. Note that the reordering of menu selections may be initiated by a selection by the user or at a predetermined interval, such as after 100 selections by the user.

A prioritization file may be generated in step 105 that may prioritize functions by category. A peripheral device may have numerous selectable functions capable of being sorted into categories such as printing functions, display functions, exposure functions, resolution functions, etc. A prioritization file may be generated that reorganizes selectable functions within each category. For example, if a user frequently selects a command to print two copies of a photo, but only infrequently selects a command to print a single copy, a prioritization file may be used to place the more frequently used printing command at the top of a menu. In other embodiments, different methods of prioritizing selectable functions may be used. A prioritization file may also be generated in step 105 that will allow reorganization of selectable functions by category. For example, if a user more frequently selects printing functions instead of display functions, a prioritization file may be generated that will result in the reorganization of selectable functions to place printing functions higher in a menu than display functions.

FIG. 2 shows a peripheral device according to an embodiment of the present invention. Peripheral device 201 in this embodiment is a digital camera with LCD display 202. LCD 202 is capable of displaying both a target scene and selectable function options. Selectable functions displayed by LCD 202 may be selected by a user with the 4-way controller and OK button 203. Note that in other embodiments, other methods of selectable function selection may be used. Alternate means of selecting functions include display button 204, share button 205 and menu button 206. In some embodiments, these alternate methods of selection may not be used, or additional methods may be included.

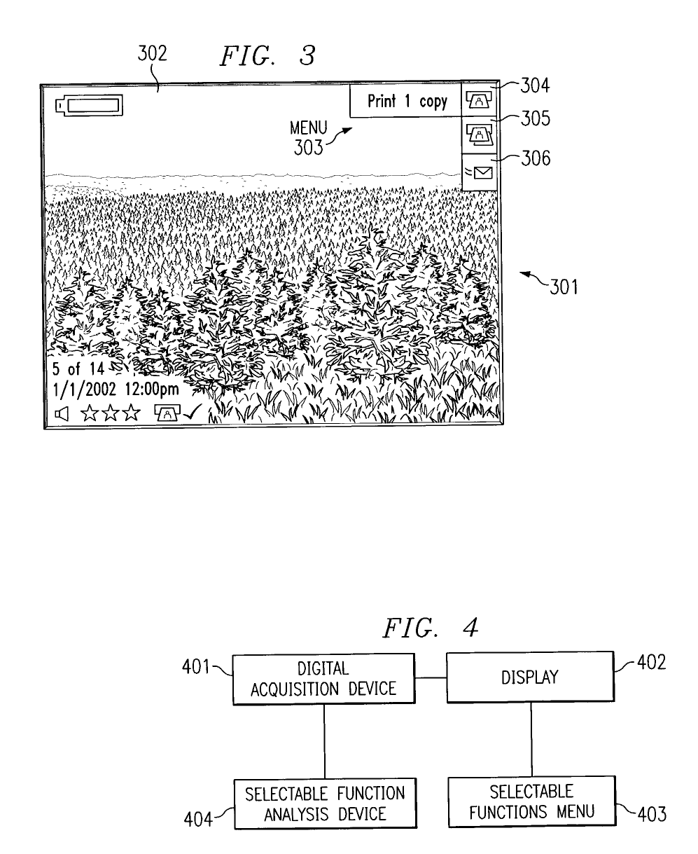

FIG. 3 shows a menu arrangement used by a peripheral device in an embodiment of the present invention. Image LCD display 301 may contain both image 302 and menu 303. In some embodiments, image 302 and menu 303 may be displayed separately. In the embodiment of FIG. 3, both image 302 and menu 303 are displayed in an overlapping manner. Menu 303 may be a vertical arrangement of selectable functions. Note that alternate menu arrangements such as horizontal ordering may be used in some embodiments. Selectable functions may include print one copy 304, print two copies 305 and e-mail copy 306. Menu 303 may include additional drop down menus or other means of displaying additional information to a user. The additional information may include other selectable functions.

FIG. 4 is a block diagram illustrating the components of a system according to an embodiment of the present invention. Digital acquisition device 401 may have display 402 such as an LCD display disposed on the device. Display 402 may display a menu of selectable functions 403 identifying operations capable of being performed by digital acquisition device 401. Digital acquisition device 401 may communicate with selectable function analysis device 404. Communications between digital acquisition device 401 and selectable function analysis device 404 may use any of a number of methods for transmitting information between devices. Examples may include parallel and serial connections, Ethernet, infrared and other wireless methods. Note that, in other embodiments, other methods of communicating information between digital acquisition device 401 and selectable function analysis device 404 may be used. In one embodiment, selectable function analysis device 404 is a computer, or includes processing capability. Selectable function analysis device 404 may be used to analyze user selection of selectable functions from the selectable functions menu 403 and generate configuration information based on the analysis. Selectable function analysis device 404 may then be used to provide the configuration information to acquisition device 401 such that selectable functions menu 403 displayed on display 402 is modified according to the configuration information.

FIG. 5 is a flow diagram illustrating a method of configuring selectable functions displayed by a peripheral device. In step 501, a peripheral device may be coupled to a remote device. In one embodiment of the present invention, a peripheral device may be a camera. A remote device may be a computer or other electronic device capable of communicating information with peripheral device. In other embodiments, peripheral devices such as cellular telephones, personal digital assistants, pagers, or other electronic instruments may be used.

In step 502, a function selection history may be generated. A function selection history may be a record of user selected peripheral device functions and may be stored on a remote device in one embodiment of the invention. In some embodiments, a function selection history may be stored on the peripheral device.

In Step 503, selectable functions displayed by the peripheral device may be configured in accordance with the function selection history generated in step 502. In one embodiment, data may be transferred from a remote device to the peripheral device to configure the display pattern of selectable functions by the peripheral device. In another embodiment, the types of selectable functions displayed by the peripheral device may be configured in accordance with the function selection history.

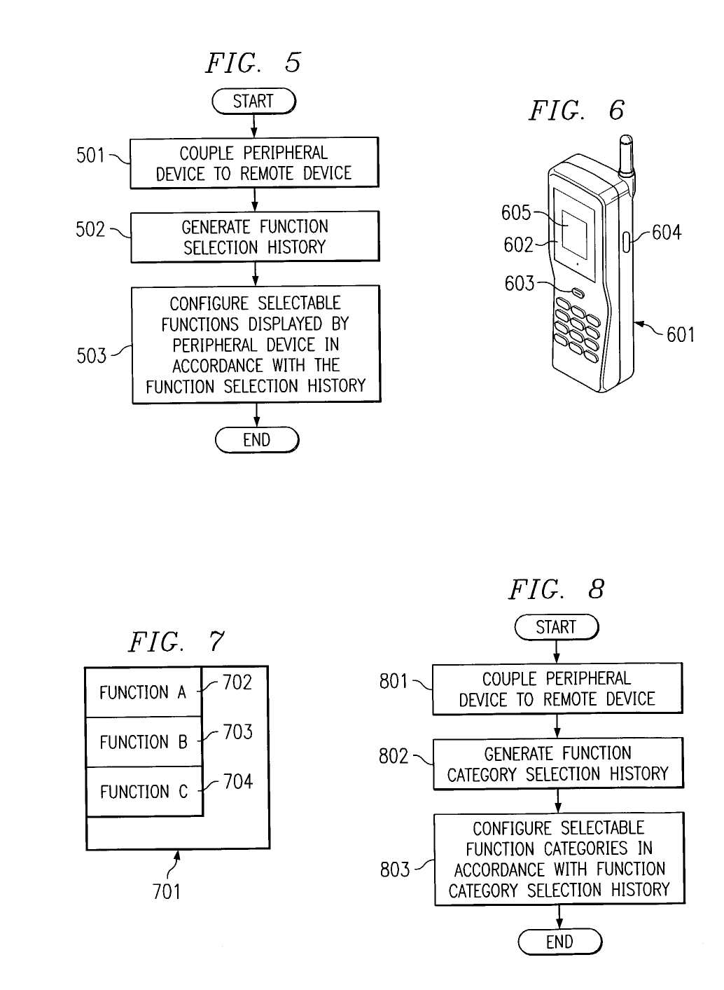

FIG. 6 shows a peripheral device according to an embodiment of the invention. Peripheral device 601 in this embodiment is a cellular phone with display 602. Display 602 may be an LCD display in some embodiments. Display 602 may be capable of displaying selectable functions to a user. Peripheral device 601 may also comprise a selection rocker button 603 that enables a user to select selectable functions. Peripheral device 601 may comprise communications port 604 that may allow a peripheral device 601 to communicate with a remote device in some embodiments. Selectable functions 605 may be displayed by peripheral device 601 on display 602 in some embodiments.

FIG. 7 shows a selectable function menu displayed by a peripheral device according to an embodiment of the present invention. Selectable function menu 701 may be displayed by a peripheral device. Selectable function menu 701 may display function A 702, function B 703, and function C 704. The number and type of functions available on selectable function menu 701 may be different in other embodiments. The position of function A 702, function B 703, and function C 704 in the selectable function menu 701 may change in accordance with a function selection history.

FIG. 8 shows a flow diagram illustrating a method of configuring selectable functions categories. In step 801, a peripheral device may be coupled to a remote device. In step 802 a function category selection history may be generated. A function category selection history may monitor both the frequency and type of function categories selected in some embodiments. Function categories may include, but are not limited to, printing functions, display functions, exposure functions, resolution functions, phone functions, or other peripheral device selectable functions. In step 803, peripheral device selectable function categories may be configured in accordance with the function category selection history generated in step 802. For example, if a user frequently selects printing functions, but infrequently selects exposure functions, a selectable function category menu may be configured such that printing functions are more easily selected than exposure functions. Function categories that are easily selected may be located at the top of a menu in some embodiments of the present invention.

What is claimed is:

1. A method for ordering selectable functions of a peripheral device comprising:
coupling said peripheral device to a remote device;
generating a function selection history; and
configuring selectable functions displayed by said peripheral device in accordance with the function selection history using data transferred from said remote device to said peripheral device.

2. The method of claim 1 wherein said configuring using data comprises configuring using prioritization data.

3. The method of claim 1 wherein said coupling to a remote device comprises coupling to remote device that generates said function selection history.

4. The method of claim 1 wherein said coupling to a remote device comprises coupling a camera with selectable functions to a remote device.

5. The method of claim 4 wherein said coupling to a remote device comprises coupling a camera comprised of a configurable user interface to a remote device.

6. The method of claim 4 wherein said coupling to a remote device comprises coupling a camera with selectable sharing functions to a remote device.

7. The method of claim 1 further comprising:
resetting said generated function selection history.

8. The method of claim 1 wherein said configuring in accordance with the function selection history comprises configuring in accordance with the function selection history using XML data.

9. A digital image acquisition system comprised of:
means for acquiring digital images;
means for providing a plurality of selectable functions; and
means for ordering said plurality of selectable functions according to frequency of use.

10. The acquisition system of claim 9 wherein said means for ordering further comprises means for connecting a computer system communicatively to said means for acquiring digital images.

11. The acquisition system of claim 10 wherein said means for ordering may be selectively disabled.

12. The acquisition system of claim 9 wherein said means for ordering includes means for prioritizing said plurality of selectable functions.

13. The acquisition system of claim 9 wherein said means for providing a plurality of selectable functions is a menu display of selectable functions.

14. The acquisition system of claim 9 wherein said means for ordering further includes means for generating function selection history data.

15. The acquisition system of claim 14 wherein said means for generating function selection history generates prioritization data.

16. A system for ordering selectable functions that are displayed on a device comprising:
a device;
a display disposed on said device;
a menu of selectable functions displayed on said display; and
an analysis device for analyzing user selection of selectable functions, said analysis device communicatively connectable to said device such that said analysis device configures said menu of selectable functions according to analysis of user selection of selectable functions.

17. The system of claim 16 wherein said menu of selectable functions displays the most frequently selected selectable function at the top of said menu.

18. The system of claim 16 wherein said analysis device may be disabled from configuring said menu of selectable functions.

19. The system of claim 16 wherein said analysis device configures said menu of selectable functions using prioritization data.

20. The system of claim 19 wherein said prioritization data is XML data.

21. The system of claim 16 wherein said device is a digital image acquisition device.

22. A computer program product comprising computer-readable code stored on computer-readable medium, said computer program comprising:
computer readable program code means for generating a function selection history;
computer readable program code means for generating a prioritization file; and
computer readable program code means for reorganizing a selectable function menu on a peripheral device connected to a computer.

23. A method for ordering selectable functions of a peripheral device comprising:
coupling said peripheral device to a remote device;
generating a function category selection history; and
configuring selectable function categories displayed by said peripheral device in accordance with the function category selection history using data transferred from said remote device to said peripheral device.

24. An apparatus for ordering selectable functions of a peripheral device comprising:
means for generating a prioritization file using a peripheral device function selection history; and
means for reorganizing peripheral device selectable functions in accordance with said prioritization file.

25. The apparatus of claim 24 wherein said means for reorganizing peripheral device selectable functions may be selectively disabled.

26. A peripheral device comprising
a selectable function menu displayed by said peripheral device;
said peripheral device communicatively connectable to a remote device; and
said peripheral device selectable function menu configurable in accordance with prioritization file data communicated to said peripheral device by said remote device.

27. The peripheral device of claim 25 wherein said prioritization file data is XML data.

28. The peripheral device of claim 25 wherein said selectable function menu displays the most frequently selected selectable function at the top of said menu.
